(19) United States
(12) Patent Application Publication
(10) Pub. No.: US 2017/0057663 A1
(43) Pub. Date: Mar. 2, 2017

(54) DEVICE FOR MANEUVERING AND IMMOBILIZING AN AIRCRAFT ON THE GROUND

(71) Applicant: AIRBUS (S.A.S.), Blagnac (FR)

(72) Inventors: Diego Alonso Tabares, Toulouse (FR); Nicolaas Peter Esteie, Tournefeuille (FR); Alexandre Fouillot, Toulouse (FR); Leonardo Canon, Toulouse (FR)

(21) Appl. No.: 15/246,080

(22) Filed: Aug. 24, 2016

(30) Foreign Application Priority Data
Aug. 25, 2015 (FR) 1557902

(51) Int. Cl. B64F 1/22; B60L 11/18; G05D 1/00

(52) U.S. Cl. CPC B64F 1/228; G05D 1/0016; B60L 11/1809

(57) ABSTRACT

A device for maneuvering and immobilizing an aircraft on the ground. Included in the device is a moving apparatus and a remote control configured for remotely controlling the moving apparatus. The device allows a coupling of a single remote control with several moving apparatuses and/or of one moving apparatus with several remote controls. Also, the device allows an operator equipped with a remote control to remotely control several pushback maneuvers by successively using several moving apparatuses or several operators each equipped with a remote control to successively control the same moving apparatus.

### CROSS-REFERENCE

The present application claims priority to a French Patent Application No. 1557902 filed Aug. 25, 2015 under 35 U.S.C. §119(a) and 365(b), which is incorporated herein by reference in its entirety.

### FIELD OF THE INVENTION

The present invention generally relates to aircraft control devices, and in particular relates to a device for maneuvering and immobilizing an aircraft on the ground.

### BACKGROUND OF THE INVENTION

Prior to takeoff, it is generally necessary to move the aircraft in order to distance it from the ground installations so that it can travel autonomously.

According to a first operating method, this movement maneuver is carried out using a motorized vehicle driven by a first operator and which pushes the aircraft away from the installations (pushback maneuver).

The motorized vehicle is connected to the front undercarriage of the aircraft and the system for controlling the steering of the front undercarriage is disengaged by the pilot of the aircraft in order to allow the undercarriage to pivot freely as a function of the steering imposed by the motorized vehicle. According to a first variant, the motorized vehicle is connected to the undercarriage by a bar. According to another variant, the motorized vehicle comprises grippers which raise the wheels of the undercarriage.

As the first operator who drives the vehicle does not have good visibility of the whole of the aircraft, a second operator walks beside the vehicle and controls the pushback maneuver.

Consequently, this first operating method is not entirely satisfactory as it requires two people on the ground.

According to a second operating method, the pushback maneuver is carried out using a remote controlled motorized vehicle. According to one embodiment, this motorized vehicle comprises a cockpit allowing it to be maneuvered and a remote control making it possible to control it remotely.

The vehicle comprises two branches which in operation are positioned on either side of a main undercarriage, each of the branches comprising two pressure rollers positioned at the front and at the back of the wheels in order to cause the wheels of the undercarriage to rotate by friction. For each branch, one of the two rollers is mobile between a retracted position in which it allows the passage of the undercarriage between the two branches and a deployed position in which the wheels of the undercarriage are clamped between the rollers.

According to this second operating method, one operator drives the motorized vehicle up to a main undercarriage of the aircraft. After having correctly positioned the branches of the vehicle on either side of the undercarriage, he commands the deployment of the rollers. He then moves away from the vehicle in order to control the pushback maneuver and to guide the pilot of the aircraft. He has a remote control to cause the stopping and the putting into rotation of the rollers and thus the movement of the aircraft.

According to this operating method, as a function of the instructions transmitted by the operator on the ground, the pilot of the aircraft orients the front undercarriage in order to steer the aircraft. At the end of the pushback maneuver, using the remote control, the operator on the ground can remotely cause the retraction of the rollers in order to release the undercarriage and the moving of the motorized vehicle in order to distance it from the aircraft.

This remote controlled motorized vehicle makes it possible to carry out the pushback maneuver with a single operator on the ground.

### SUMMARY OF THE INVENTION

The purpose of the present invention is to improve the ergonomics of a device for maneuvering an aircraft on the ground.

For this purpose, the invention relates to a device for maneuvering an aircraft on the ground comprising: a moving apparatus which comprises a movement system and a mechanism for coupling with an aircraft undercarriage, and a remote control configured for remotely controlling the moving apparatus.

The device comprises a first wireless communication system which uses a communication protocol for exchanging information between the remote control and the moving apparatus, the communication protocol allowing the coupling of a single remote control with several moving apparatuses and/or of one moving apparatus with several remote controls.

This system allows an operator on the ground equipped with a remote control to remotely and safely control several successive pushback maneuvers using several moving apparatuses or several operators each equipped with a remote control to control the same moving apparatus successively.

Advantageously, the moving apparatus and the remote control each comprises its own identifier.

According to another feature, the remote control is a device with a touch screen upon which at least two graphic elements are shown, each one dedicated to one instruction, a first graphic element being associated with an instruction to initiate a movement of the moving apparatus in a first direction and a second graphic element associated with an instruction to stop the movement.

The fact of providing a restricted number of graphic elements, each one dedicated to one instruction, simplifies the control of the operations of maneuvering the aircraft on the ground and improves the ergonomics of the device. A pushback maneuver can therefore be carried out by a single operator on the ground, while limiting the risk of incidents.

Advantageously, the moving apparatus comprises a mechanism for immobilizing the moving apparatus on the ground and the touch screen of the device comprises a third graphic element associated with an instruction to activate or to deactivate the mechanism for immobilizing the moving apparatus on the ground.

Preferably the touch screen of the device comprises a fourth graphic element associated with an instruction to initiate a movement of the moving apparatus in a second direction opposite to the first direction.

According to a first variant, the mechanism for immobilizing the moving apparatus on the ground comprises at least one brake for immobilizing at least one of the wheels of the moving apparatus.

According to another variant, the moving apparatus comprises a chassis supported by wheels and the mechanism for immobilizing the moving apparatus on the ground comprises at least one articulation making it possible to lower the chassis with respect to at least one of the wheels of the moving apparatus so that the chassis occupies a first position in which the chassis is distanced from the ground and a second position in which the chassis is in contact with the ground.

According to another feature, the moving apparatus comprises a detection system and the device comprises software configured for controlling the system for moving the moving apparatus from a first point to a second point on the basis of information received from the detection system.

Advantageously, the device comprises at least one base where the moving apparatus is stored when it is not in use, the base being configured for making it possible to recharge the moving apparatus with electrical energy.

According to another feature, the remote control comprises an application which makes it possible to enter an aircraft identifier, to initiate a movement of the moving apparatus up to an undercarriage or from the undercarriage, to activate or to deactivate the coupling mechanism and to display the graphic elements.

Preferably, the device comprises a second communication system allowing an exchange of information between an operator on the ground and a cockpit of the aircraft.

The foregoing and other aspects and features of the invention will become apparent to those of reasonable skill in the art from the following detailed description, as considered in conjunction with the accompanying drawings.

### BRIEF DESCRIPTION OF THE DRAWINGS

FIG. 1 is a plan view of an aircraft immobilized in a parking area and of a moving apparatus of a device for maneuvering an aircraft on the ground;

FIG. 2 is a perspective view of the moving apparatus shown in FIG. 1 coupled with a main undercarriage;

FIG. 3 is a perspective view of a device for maneuvering and immobilizing an aircraft on the ground which illustrates one embodiment of the invention;

FIG. 4 is a plan view of a moving apparatus which illustrates one embodiment of the invention;

FIG. 5 is a side view of the moving apparatus shown in FIG. 4; and

FIG. 6 is a representation of a screen of a remote control of a device for maneuvering an aircraft on the ground which illustrates one embodiment of the invention.

### DETAILED DESCRIPTION OF THE PREFERRED EMBODIMENTS

Preferred embodiments of the present invention are described below by way of example only, with reference to the accompanying drawings. Further, the following description is merely exemplary in nature and is in no way intended to limit the invention, its application, or uses. As used herein, the term “module” or “unit” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. Thus, while this invention includes particular examples and arrangements of the modules, the scope of the present system should not be so limited since other modifications will become apparent to the skilled practitioner.

FIG. 1 shows, at 10, an aircraft immobilized on a parking area 12. According to one configuration, the parking area 12 corresponds to an embarkation area.

The aircraft 10 comprises an orientable front undercarriage 14 and two main undercarriages 16.

When the aircraft 10 is immobilized in the parking area 12, the position of each undercarriage 14 and 16 is known.

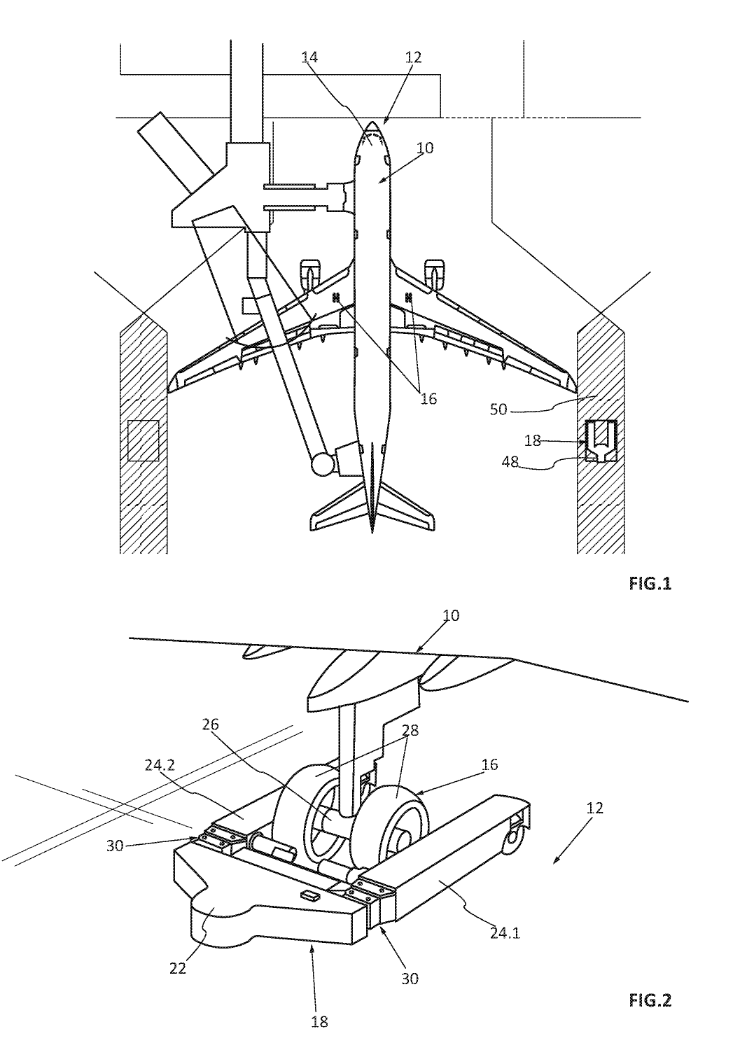

FIGS. 2, 3 and 4, show a device for maneuvering an aircraft on the ground which comprises a motorized and remote-controlled moving apparatus 18 and a remote control 19 configured for controlling the moving apparatus 18.

The moving apparatus 18 comprises a chassis 20 with a base 22 and two branches 24.1, 24.2 parallel with each other and each connected to the base 22. In the continuation of the description, “reference plane Pr” refers to a plane parallel with the ground and “longitudinal direction” refers to the direction parallel with the reference plane Pr and oriented along the length of the branches 24.1, 24.2.

As shown in FIG. 4, the separation E between the branches 24.1, 24.2 is such that, during operation, a main undercarriage 16 is inserted between the two branches 24.1, 24.2 which are oriented parallel with the longitudinal direction and perpendicular to the axes of rotation 26 of the wheels 28 of the main undercarriage 16 (visible in FIGS. 2 and 4).

According to a first variant which is not shown, the branches 24.1, 24.2 are connected by a rigid link to the base 22 and, in this case, the separation E between the branches 24.1, 24.2 is fixed.

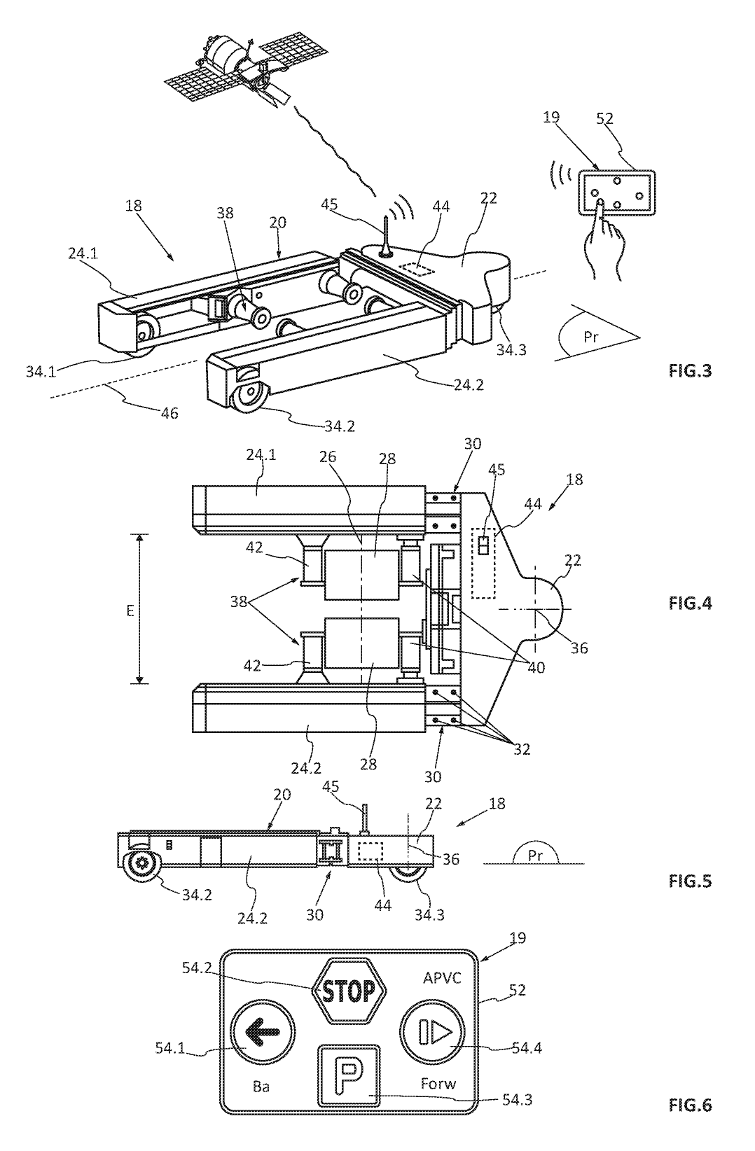

According to another variant shown in FIGS. 3 to 5, the separation E between the branches 24.1, 24.2 is adjustable. According to this variant, at least one of the branches 24.1, 24.2 is connected to the base 22 by an articulation 30 which makes it possible to vary the separation E. According to one embodiment, each articulation 30 comprises at least one pair of parallel rods, each end of each rod being connected to the base 22 or to a branch 24.1, 24.2 by a pivoting axis 32 perpendicular to the reference plane Pr.

The chassis 20 is supported by at least three wheels 34.1, 34.2, 34.3. According to one configuration, a first wheel 34.1 is positioned at one end of the branch 24.1 opposite to the base 22, a second wheel 34.2 is positioned at one end of the branch 24.2 opposite to the base 22 and a third wheel 34.3 is connected to the base 22 and positioned equidistant from the branches 24.1 and 24.2.

At least one of the wheels 34.1, 34.2, 34.3 is orientable. For this purpose, the orientable wheel is connected to the chassis 20 by a link pivoting about a pivoting axis 36 perpendicular to the reference plane Pr. This configuration allows the moving apparatus to follow a curved trajectory.

According to one configuration, all of the wheels 34.1 to 34.3 are orientable.

According to one embodiment, for each orientable wheel, the wheel is connected to a yoke by means of an axis of rotation parallel to the reference plane Pr and each yoke is connected to the chassis 20 by a pivoting axis 36 perpendicular to the reference plane Pr. An actuator in interposed between the chassis 20 and the yoke in order to cause its pivoting about the pivoting axis 36.

The moving apparatus 18 comprises at least one mechanism for controlling the orientation of at least one wheel 34.1 to 34.3. Advantageously, this mechanism for controlling the orientation can be disengaged.

At least one wheel 34.1, 34.2, 34.3 is a driving wheel. For this purpose, the moving apparatus comprises at least on a motorization configured for driving the wheel in rotation. Advantageously, the moving apparatus comprises at least one clutch for coupling or not coupling the driving wheel or wheels to the motorizations.

Whatever the variant may be, the moving apparatus 18 comprises a moving system which comprises the wheels 34.1 to 34.3 as well as the means used for orienting them and ensuring their drive function and which makes it possible for the moving apparatus to move on the ground.

The moving apparatus 18 comprises at least one mechanism 38 for coupling the moving apparatus 18 and the main undercarriage 16. Preferably, the coupling mechanism 38 comprises at least one roller configured for driving at least one wheel of the aircraft in rotation by friction.

According to one embodiment, at least one of the branches 24.1, 24.2 comprises a first roller 40 close to the base 22 and oriented towards the space between the two branches 24.1 and 24.2 and a second roller 42 distanced from the first roller 40 in the longitudinal direction, the second roller 42 being mobile between a retracted position in which the second roller 42 is positioned on the inside of the branch 24.1, 24.2 to which it is connected and allows the passage of the wheels of the undercarriage between the branches 24.1 and 24.2 and a deployed position in which the second roller 42 is positioned on the outside of the branch 24.1, 24.2 and oriented towards the space between the two branches 24.1, 24.2 in order to clamp the wheel 28 of the aircraft between the first and second rollers 40, 42, the axis of the second roller 42 being perpendicular to the longitudinal direction and parallel with the reference plane Pr. The coupling mechanism 38 comprises at least one actuator to cause the passage from the deployed position to the retracted position or vice versa.

At least one of the rollers is a drive roller and is coupled to a motorization for driving it in rotation. When it is put into rotation, each drive roller drives the wheel of the undercarriage in rotation by friction.

Preferably, the actuators and motors of the moving system and of the coupling mechanism 38 are electrical.

For this purpose, the moving apparatus 18 comprises a battery making it possible to store electrical energy and a system for controlling the charging and recharging of the battery. Advantageously, the moving apparatus 18 comprises a connector fixed with respect to the chassis 20 which can be connected to an electrical energy supply for recharging the battery.

The different actuators and motors of the moving apparatus 18 of the moving system and of the coupling mechanism 38 are controlled by a controller 44 integral with the chassis 20.

The device for maneuvering an aircraft on the ground comprises a first wireless communication system 45 ensuring the exchange of information between the moving apparatus 18 and the remote control 19. Preferably, the first communication system uses a communication protocol of the Wi-Fi type.

According to the invention, the moving apparatus 18 comprises at least one positioning and/or navigation sensor.

According to a first variant, the positioning and/or navigation sensor is a satellite positioning and navigation sensor of the GPS type, for example, making it possible to determine the positioning coordinates of the moving apparatus 18 in a system of reference axes.

According to a second variant, the positioning and/or navigation sensor is a trajectory following sensor configured for following a trajectory 46 on the ground. According to one embodiment, the trajectory following sensor is a sensor of the RFID type configured for detecting beacons of the RFID chip type installed in or on the ground according to a trajectory 46. According to another embodiment, the trajectory following sensor is a camera which is associated with image recognition software and which detects a marking on the ground. According to another embodiment, the trajectory following sensor is an electromagnetic sensor configured for detecting a wire positioned in the ground and according to a trajectory to be followed. Other solutions can be envisaged for the trajectory following sensor.

According to a third variant, the positioning and/or navigation sensor is a sensor for detecting the position of the undercarriage. This type of sensor makes it possible to determine the position of the moving apparatus 18 with respect to the undercarriage more precisely. According to one embodiment, the detection sensor is an ultrasonic sensor. However, other solutions can be envisaged for the sensor for detecting the position of the undercarriage.

Whatever the variant may be, the moving apparatus 18 comprises a detection system comprising at least one positioning and/or navigation sensor.

Advantageously, the device for maneuvering an aircraft on the ground comprises at least one base 48 where the moving apparatus 18 is positioned when it is not in use.

This base 48 is situated close to the parking area 12, in a parking area 50 for ground support equipment.

Advantageously, the base 48 is configured for recharging the moving apparatus 18 immobilized on the base 48 with electrical energy. According to one embodiment, the base 48 comprises a connector configured for being connected to a connector of the moving apparatus 18 in order to recharge its batteries.

According to one embodiment, the device for maneuvering an aircraft on the ground comprises at least software making it possible, starting from a first move instruction, to move the moving apparatus 18 automatically and autonomously from the base 48 up to a main undercarriage 16 of an aircraft and, starting from a second move instruction, to move the moving apparatus 18 automatically and autonomously from a main undercarriage 16 up to the base 48. For this purpose, the software analyzes information transmitted by the detection system and transmits information to the controller 44 in order to control the motor or motors and the actuator or actuators of the moving apparatus 18.

Generally, the software makes it possible for the moving apparatus to move from a first point to a second point autonomously and automatically, notably up to an undercarriage or from an undercarriage.

According to one configuration, the software is implemented in the controller 44.

According to another feature of the invention, the moving apparatus 18 comprises an immobilizing mechanism for immobilizing it. Thus, it is possible to use the moving apparatus 18 as a chock. Because of this, an operator can remotely control the moving apparatus 18 so that it moves from its base 48 up to a main undercarriage 16 and, once it is correctly positioned with respect to the undercarriage, so that the rollers 42 move into the deployed position. Afterwards, by activating the immobilizing mechanism of the moving apparatus 18, the wheels of the aircraft being clamped by the moving apparatus 18 are thus immobilized on the ground. Thus, the operator in charge of the maneuver does not have to approach the wheels of the aircraft.

According to a first variant, the moving apparatus 18 comprises at least one brake for immobilizing at least one of its wheels 34.1 to 34.3.

According to another variant, the moving apparatus 18 comprises at least one articulation making it possible to lower the chassis 20 with respect to at least one wheel 34.1 to 34.3 so that the chassis 20 is in contact with the ground. Thus, the chassis 20 occupies a first position in which it is distanced from the ground and allows the moving apparatus 18 to move and a second position in which it is in contact with the ground and immobilizes the moving apparatus 18. Preferably, the moving apparatus 18 comprises several articulations making it possible to lower the chassis 20 with respect to all of the wheels. This solution makes it possible to increase the contact area between the chassis 20 and the ground in the second position.

Advantageously, the controller 44 makes it possible to activate or not activate the immobilizing mechanism of the moving apparatus 18 on reception of a third instruction.

According to another feature of the invention, the remote control 19 is a device 52 with a touch screen upon which are shown graphic elements 54.1 to 54.4, for example, in the form of a virtual button (shown in FIG. 6). The device 52 can, for example, be a tablet with a touch screen, a smartphone, etc.

Each of the graphic elements 54.1 to 54.4 is dedicated to one instruction. Thus, a first graphic element 54.1 makes it possible to initiate the movement of the moving apparatus in a first direction, for example in order to push back the aircraft, a second graphic element 54.2 makes it possible to stop the movement of the moving apparatus 18, a third graphic element 54.3 makes it possible to activate or to deactivate the mechanism for immobilizing the moving apparatus 18 on the ground and a fourth graphic element 54.4 makes it possible to initiate the movement of the moving apparatus in a second direction opposite to the first direction, for example in order to make the aircraft move forward.

At a minimal level, the touch screen of the device 52 comprises two graphic elements, a first graphic element 54.1 for initiating the movement of the aircraft in a first direction and a second graphic element 54.2 for commanding the stopping of the movement of the aircraft.

The graphic elements 54.1 to 54.4 are disposed at the points of a geographic shape which extends over the whole of the area of the touch screen of the device 52. For example, when there are four graphic elements 54.1 to 54.4, they are arranged at the points of a diamond shape, of a square or of a rectangle which occupies all of the area of the touch screen of the device 52.

Such an arrangement (in number and disposition) of graphic elements 54.1 to 54.4 distributed over the whole area of the touch screen of the device 52 simplifies the control of the operations of maneuvering the aircraft on the ground and improves the ergonomics of the device for maneuvering an aircraft on the ground. Thus, the operator in charge of controlling the pushback maneuver remains attentive to the environment of the aircraft, which tends to limit the risk of incidents.

According to another feature, a single remote control 19 can control several moving apparatuses 18 and/or a single moving apparatus 18 can be controlled by several remote controls 19.

For this purpose, each moving apparatus 18 and each remote control comprises an identifier which is unique to it and which is different from the identifiers of the other mobile apparatuses and of the other remote controls 19.

The coupling of the remote control and the moving apparatus is carried out using the communication protocol.

According to one embodiment, the device 52 comprises an electronic module making it possible to identify another device operating with the same communication protocol and to select it in order to obtain a coupling of the remote control and the moving apparatus.

It is possible for the device 52 to not be dedicated to the pushback maneuver.

Preferably, the device 52 comprises an application which makes it possible to carry out the pushback maneuver.

Advantageously, this application comprises a first display making it possible to enter an aircraft identifier. This solution makes it possible to be able to determine the position of the main undercarriage 16 around which the moving apparatus 18 must be positioned and thus to determine the trajectory that the moving apparatus 18 must follow in order to reach the main undercarriage 16.

This first display also comprises at least one graphic element representing a button for initiating the first instruction to move the moving apparatus 18 from the base 48 to the main undercarriage 16 and to activate the coupling mechanism 38 and at least one graphic element representing a button for initiating the second instruction to deactivate the coupling mechanism 38 and to move the moving apparatus 18 from the main undercarriage 16 to the base 48.

The application also comprises a second display which makes it possible to display the graphic elements 54.1 to 54.4 shown in FIG. 6.

According to another feature, the device for maneuvering an aircraft on the ground comprises a second communication system allowing an exchange of information between an operator on the ground in charge of controlling the maneuver of the aircraft and a cockpit of the aircraft.

This second communication system comprises a headset with headphones and a microphone worn by the operator on the ground allowing him to dialog with the pilot of the aircraft.

This communication system can use different communication protocols such as Wi-Fi, VHF, etc.

According to a first embodiment, the headset communicates using a communication protocol of the Wi-Fi, Bluetooth type with a unit connected to an intercom of the aircraft.

According to a second embodiment, the headset communicates using a communication protocol of the Wi-Fi, Bluetooth type with the controller 44 of the moving apparatus which communicates with the pilot using a VHF type communication.

According to a third embodiment, the headset communicates with the pilot of the aircraft using a VHF type communication.

According to one operating mode, when an aircraft 10 reaches a parking area 12, an operator, using the remote control 19, remotely controls the movement of the moving apparatus 18 from the base 48 up to the main undercarriage 16, the deployment of the rollers 42 for clamping at least one of its wheels and the activation of the immobilizing mechanism of the moving apparatus 18. Thus, the moving apparatus 18 provides the chock function for immobilizing the aircraft on the ground.

When he wishes to carry out a pushback operation, an operator deactivates the immobilizing mechanism of the moving apparatus 18 using the remote control 19. Afterwards, he initiates the putting of the aircraft into movement in the desired direction by activating the putting of the roller or rollers 40, 42 into rotation in the appropriate direction of rotation, by clicking on the first graphic element 54.1.

During the pushback maneuver, the operator guides the pilot by means of the second communication system and monitors the environment of the aircraft. The operator on the ground can stop the pushback maneuver at any time by clicking on the second graphic element 54.2. If necessary he can activate the mechanism for immobilizing the moving apparatus 18, in order to immobilize the aircraft on the ground, by clicking on the graphic element 54.3. If the aircraft has to return to its starting position, the operator on the ground initiates the putting into movement of the aircraft in the desired direction by activating the putting of the roller or rollers 40, 42 into rotation in the appropriate direction of rotation by clicking on the graphic element 54.4.

During the maneuvering of the aircraft on the ground, the pilot controls the orientation of the front undercarriage according to the instructions given by the operator on the ground.

At the end of the pushback maneuver, the operator can remotely command the retraction of the rollers 42, in order to release the main undercarriage 16, and the movement of the moving apparatus 18 from the main undercarriage 16 back to the base 48.

Thus, according to the invention, only one operator on the ground is necessary for carrying out the pushback maneuver in total safety.

Moreover, the device of the invention makes it possible for an operator to avoid approaching the wheels of the undercarriages. Thus, all of the operations of chocking and maneuvering the aircraft on the ground are carried out at a distance from the aircraft.

While at least one exemplary embodiment of the present invention has been shown and described, it should be understood that modifications, substitutions and alternatives may be apparent to one of ordinary skill in the art and can be made without departing from the scope of the invention described herein. This application is intended to cover any adaptations or variations of the specific embodiments discussed herein. In addition, in this application, the terms “comprise” or “comprising” do not exclude other elements or steps, and the terms “a” or “one” do not exclude a plural number. Furthermore, characteristics or steps which have been described with reference to one of the above exemplary embodiments may also be used in combination with other characteristics or steps of other exemplary embodiments described above.

What is claimed is:

1. A device for maneuvering an aircraft on the ground comprising:
a moving apparatus, which comprises a movement system and a mechanism for coupling with an aircraft undercarriage, and
a remote control configured for remotely controlling the moving apparatus,
wherein the device comprises a first wireless communication system which uses a communication protocol for exchanging information between the remote control and the moving apparatus,
the communication protocol being configured to couple at least one of:
a single remote control with several moving apparatuses, and
one moving apparatus with several remote controls,
the remote control being an electronic module configured to identify another apparatus operating with the same communication protocol and to selectively obtain a coupling of the remote control and a moving apparatuses.

2. The device according to claim 1, wherein the moving apparatus and the remote control each comprises its own identifier.

3. The device according to claim 1, wherein the remote control is a device with a touch screen upon which at least two graphic elements are shown, each one dedicated to one instruction, a first graphic element being associated with an instruction to initiate a movement of the moving apparatus in a first direction and a second graphic element associated with an instruction to stop the movement.

4. The device according to claim 3, wherein the moving apparatus comprises a mechanism for immobilizing the moving apparatus on the ground and wherein the touch screen of the device comprises a third graphic element associated with an instruction to activate or to deactivate the mechanism for immobilizing the moving apparatus.

5. The device according to claim 4, wherein the touch screen of the device comprises a fourth graphic element associated with an instruction to initiate a movement of the moving apparatus in a second direction opposite to the first direction.

6. The device according to claim 4, wherein the mechanism for immobilizing the moving apparatus on the ground comprises at least one brake for immobilizing at least one of wheels of the moving apparatus.

7. The device according to claim 4, wherein the moving apparatus comprises a chassis supported by wheels and wherein the mechanism for immobilizing the moving apparatus on the ground comprises at least one articulation configured to lower the chassis with respect to at least one of the wheels of the moving apparatus so that the chassis occupies a first position in which the chassis is distanced from the ground and a second position in which the chassis is in contact with the ground.

8. The device according to claim 1, wherein the moving apparatus comprises a detection system and wherein the device comprises software configured for controlling the system for moving the moving apparatus from a first point to a second point on the basis of information received from the detection system.

9. The device according to claim 1, wherein the device comprises at least one base where the moving apparatus is stored when not in use, the base being configured for recharging the moving apparatus with electrical energy.

10. The device according to claim 1, wherein the remote control comprises an application which enables to enter an aircraft identifier, to initiate a movement of the moving apparatus up to an undercarriage or from the undercarriage, to activate or to deactivate the coupling mechanism and to display the graphic elements.

11. The device according to claim 1, further comprising a second communication system allowing an exchange of information between an operator on the ground and a cockpit of the aircraft.
